(19) United States
(12) Patent Application Publication
(10) Pub. No.: US 2005/0010474 A1
(43) Pub. Date: Jan. 13, 2005

(54) Methods, systems and computer program products for paperless third-party billing of business directory advertisements

(76) Inventor: Wealthy Desai, Atlanta, GA (US)

Correspondence Address: MYERS BIGEL SIBLEY & SAJOVEC, PO BOX 37428, RALEIGH, NC, 27627, US

(21) Appl. No.: 10/617,959

(22) Filed: Jul. 11, 2003

(51) Int. Cl. G06F 17/60

(52) U.S. Cl. 705/14; 705/40

(57) ABSTRACT

Tear pages and business directory publisher invoices for business directory advertisements that were sold by third party Customer Marketing Representatives (CMRs) for a business directory publisher to CMR customers are distributed paperlessly. The tear pages and CMR customer invoices for business directory advertisements that were sold by the CMRs to CMR customers also may be distributed paperlessly. Paperless tear pages and billing can reduce the potentially large printing, postage and/or manual labor costs associated with conventional tear page and invoice distribution.

### FIELD OF THE INVENTION

This invention relates to data processing systems, methods and/or computer program products, and more particularly to automated billing methods, systems and/or computer program products.

### BACKGROUND OF THE INVENTION

Business directories such as Yellow Pages business directories and/or other telephone directories are widely distributed and used to identify products and services. Many business directories are distributed for free, at great potential expense, such that advertising revenue from these directories may be used to sustain their distribution. As used herein, a “business directory” is a publication including listings for a plurality of businesses or commercial entities. Each listing may include, for example, the name, address and telephone number of the business. The listings may be organized alphabetically by business name, categorized or classified according to relevant category or categories of products and/or services offered by the respective businesses and/or otherwise organized.

As is well known to those having skill in the art, the business directory advertising industry uses third party advertisement sellers, referred to as Customer Marketing Representatives (CMRs). A CMR sells business directory advertisements to customers for the business directory publisher. Once an advertisement is sold, the business directory publisher bills the CMR, and the CMR in turn bills its customers.

In order to provide this billing, the business directory publisher “tears” a business directory advertisement, to generate what is referred to in the industry as a “tear page”, and sends the tear page to the CMR along with an invoice. The CMR may add a commission and generate its own invoice, which is sent to the CMR's customers.

### SUMMARY OF THE INVENTION

Some embodiments of the present invention paperlessly distribute to third party Customer Marketing Representatives (CMRs) for a business directory publisher, tear pages and business directory publisher invoices for business directory advertisements that were sold by the CMRs to CMR customers. Other embodiments of the invention paperlessly distribute to the CMR customers, the tear pages and CMR customer invoices for business directory advertisements that were sold by the CMRs to the CMR customers. Accordingly, methods, systems and/or computer program products that employ paperless tear pages and billing can reduce the potentially large printing, postage and/or manual labor costs associated with conventional tear page and invoice distribution.

In some embodiments of the present invention, an electronic image of a business directory advertisement that was sold by a CMR for the business directory publisher is generated. Also generated is an electronic invoice for the business directory advertisement that was sold by the CMR for the business directory publisher. The electronic image and the electronic invoice are electronically linked. Electronic access to the electronic image and electronic invoice that are electronically linked is granted to the CMR.

In some embodiments, electronic access is granted to the CMR by sending an email to the CMR including a hyperlink to the electronically linked electronic image and electronic invoice. In other embodiments, electronic access is granted to the CMR by sending an email to the CMR including a user identifier (userid) and/or password that may be used to electronically access the electronically linked electronic image and electronic invoice. Moreover, in some embodiments, the electronic image and the electronic invoice are electronically linked by generating a hyperlink to the electronic image in the electronic invoice.

In other embodiments of the present invention, the generating of an electronic image, the generating of an electronic invoice and the electronically linking of the electronic image and the electronic invoice are repeatedly performed for a plurality of business directory advertisements that were sold by the CMR for the business directory publisher to create an invoice summary statement. Electronic access is then granted to the CMR to the invoice summary statement.

In some embodiments, the electronic image is a read-only portable document format (PDF) file that contains the image of the business directory advertisement. In other embodiments, the electronic invoice is an electronic spreadsheet that contains the electronic invoice. In other embodiments, the electronic invoice is a PDF file and/or a word processing document containing the electronic invoice.

Some embodiments of the invention also include electronically sending a reminder message to the CMR if the CMR has not electronically accessed the electronically linked electronic image and electronic invoice within a predetermined time after the granting of electronic access. Moreover, in other embodiments, an electronic CMR credit/debit form is accepted by the business directory publisher. The CMR credit/debit form indicates that an error was made in the electronic invoice. Also, in other embodiments, an electronic CMR adjustment form is accepted by the business directory publisher. The electronic CMR adjustment form indicates that an error was made in the business directory advertisement.

In other embodiments of the present invention, an electronically linked electronic image of a business directory advertisement that was sold by the CMR to a CMR customer and a corresponding CMR electronic invoice for the business directory advertisement that was sold by the CMR to the CMR customer are configured to be electronically accessed by the CMR customer, in response to granting access to the electronically linked electronic image and electronic invoice by the business directory publisher. The CMR generates a customer electronic invoice for the business directory advertisement that was sold by the CMR to the CMR customer, from the CMR electronic invoice. The electronic image and the customer electronic invoice are electrically linked. Electronic access is granted to the CMR customer to the electronically linked electronic image and customer electronic invoice. Access may be granted by sending an email to the CMR customer including a hyperlink and/or a userid and/or password, as was described above. The CMR may also send an electronic credit/debit form and/or an electronic CMR adjustment form to the business directory publisher, as was described above.

It will be understood that embodiments of the invention have been described above primarily with regard to business directory advertisement billing methods. However, analogous systems and/or computer program products also may be provided. Moreover, although embodiments of the invention were described above in connection with business directory advertisement billing, other embodiments of the present invention can provide general advertisement billing methods, systems and/or computer program products for a publisher, such as a periodical or directory publisher, with respect to third party Marketing Representatives (MR) for the publisher. Although embodiments of the present invention may be used for advertising performed by any publisher, embodiments of the invention may have particular utility with respect to business directory advertisements using CMRs, due to the potentially large volume of these advertisements and the potentially large dependence on advertising revenue by the business directory publisher.

### BRIEF DESCRIPTION OF THE DRAWINGS

FIG. 1 is a block diagram of systems, methods and/or computer program products according to some embodiments of the present invention.

FIGS. 2-7 are flowcharts of operations that may be performed according to various embodiments of the present invention.

FIG. 8 is a functional block diagram of systems, methods and/or computer program products according to other embodiments of the present invention.

FIGS. 9-14 are examples of user interfaces that may be used in some embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the flnction/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

As will be appreciated by one of skill in the art, the present invention may be embodied as a method, data processing system and/or computer program product. Thus, the present invention may take the form of an entirely hardware embodiment, an entirely software embodiment or an embodiment combining software and hardware aspects, which may be collectively referred to herein as a “circuit” or “module”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

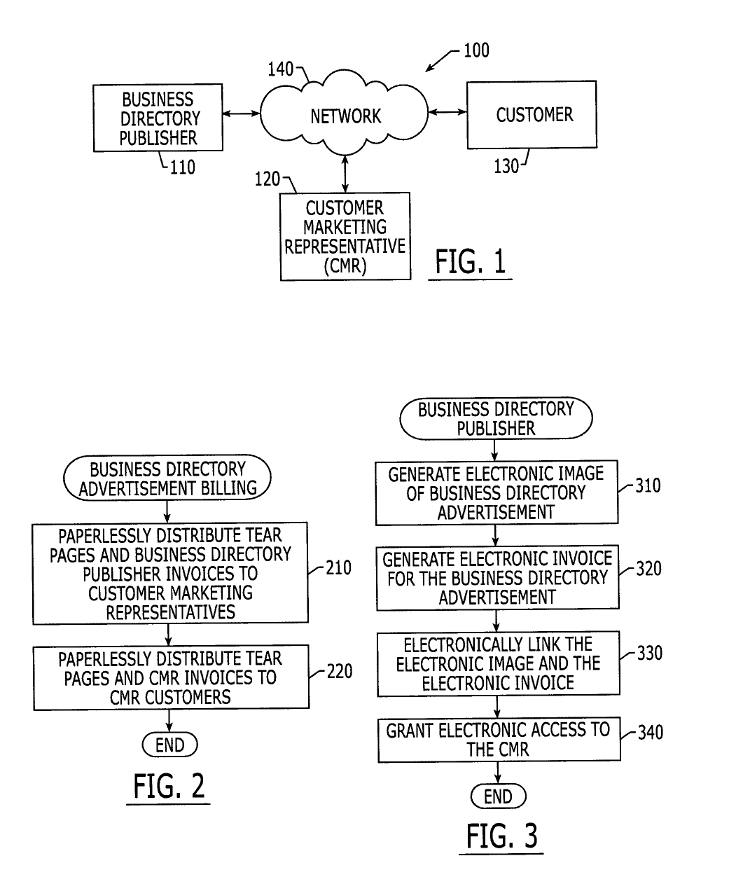

FIG. 1 is a block diagram of systems, methods and/or computer program products for business directory advertisement billing according to some embodiments of the present invention. As shown in FIG. 1, these systems, methods and/or computer program products 100 include business directory publisher billing systems, methods and/or computer program products 110, Customer Marketing Representative (CMR) billing systems, methods and/or computer program products 120, and customer billing systems, methods and/or computer program products 130.

It will be understood that the business directory publisher billing system, methods and/or computer program products 110, the CMR billing systems, methods and/or computer program products 120, and the customer billing systems, methods and/or computer program products 130 may each be embodied as one or more enterprise, application, personal and/or pervasive computer systems that may be interconnected via one or more networks, such as a local and/or wide area network including an intranet and/or the Internet. Moreover, the business directory publisher billing systems, methods and/or computer program products 110, the CMR billing systems, methods and/or computer program products 120, and the customer billing systems, methods and/or computer program products 130 may be interconnected by a network 140, which may include one or more local and/or wide area networks, including an intranet and/or the Internet. It also will be understood that, although a single business directory publisher billing system, method and/or computer program product 110, CMR billing system, method and/or computer program product 120, and/or customer billing system, method and/or computer program product 130 is shown in FIG. 1, multiple systems, methods and/or computer program products of each or selected ones 110, 120 and 130 may be present in other embodiments of the present invention.

FIG. 2 is a flowchart of operations that may be performed for business directory advertisement billing according to various embodiments of the present invention. As shown at Block 210, tear pages and business directory publisher invoices for business directory advertisements that were sold by CMRs to CMR customers are paperlessly distributed to the CMRs. Operations of Block 210 may be performed, for example, by business directory publisher billing systems, methods and/or computer program products 110 of FIG. 1. Moreover, as shown at Block 220, other embodiments of the invention also include paperlessly distributing to the CMR customers, the tear pages and CMR customer invoices for business directory advertisements that were sold by the CMRs to the CMR customers. These operations may be performed by CMR billing systems, methods and/or computer program products 120 of FIG. 1.

FIG. 3 is a flowchart of operations that may be performed by or for a business directory publisher, for example using a business directory publisher system, method and/or computer program product 110 of FIG. 1 and/or a paperless distribution Block 210 of FIG. 2. In particular, referring to FIG. 3, at Block 310, an electronic image (also referred to as an “electronic tear page”) of a business directory advertisement that was sold by a third party CMR for the business directory publisher is generated. In some embodiments of the present invention, the electronic image is a read-only portable document format (PDF) file of the image. At Block 320, an electronic invoice for the business directory advertisement that was sold by the CMR for the business directory publisher is generated. The electronic invoice may be provided by generating an electronic spreadsheet, such as a Microsoft Excel spreadsheet that contains the electronic invoice (and/or data used to create the electronic invoice). In other embodiments, a PDF file and/or a word processing file, such as a Microsoft Word document file, can contain the electronic invoice.

Still referring to FIG. 3, at Block 330, the electronic image and the electronic invoice are electronically linked. For example, electronic linking may be provided by generating a hyperlink to the electronic image in the electronic invoice. Other conventional electronic linking techniques may be used. Then, at Block 340, electronic access is granted to the CMR to allow the CMR to access the electronically linked electronic image and electronic invoice. In some embodiments, electronic access is granted by sending an email to the CMR including a hyperlink to the electronically linked electronic image and electronic invoice. In other embodiments, electronic access is granted by sending an email to the CMR including a userid and/or password that may be used to electronically access the electronically linked electronic image and electronic invoice. The email can be sent to a general CMR mailbox, a single CMR email address and/or a list of CMR email addresses. Other conventional electronic access techniques may be employed, such as posting to a secure website.

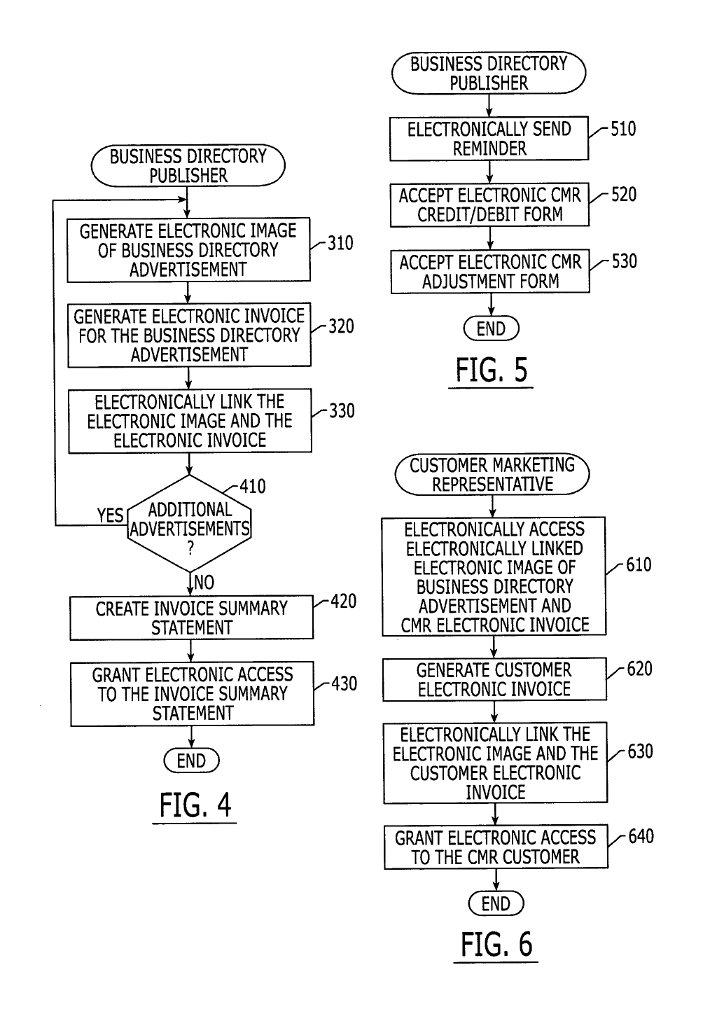

FIG. 4 is a flowchart of operations that may be performed by or for a business directory publisher to generate multiple invoices and an invoice summary statement, according to some embodiments of the invention. As was the case with FIG. 3, these operations may be performed by the business directory publisher billing systems, methods and/or computer program products 110 of FIG. 1 and may constitute embodiments of Block 210 of FIG. 2.

Referring now to FIG. 4, the operations of Blocks 310, 320, and 330 are performed. Then, at Block 410, a test is made as to whether additional business directory advertisements are to be electronically billed to a particular CMR. If yes, the operations of Blocks 310, 320 and 330 are repeatedly performed for a plurality of business directory advertisements that were sold by the CMR for the business directory publisher. Once a plurality of, and in some embodiments, all, additional advertisements are processed at Block 410, an invoice summary statement is created at Block 420. Then, at Block 430, electronic access to the invoice summary statement is granted to the CMR. Electronic access may be granted using one or more of the techniques that were described in connection with Block 340 of FIG. 3.

FIG. 5 is a flowchart of other operations that may be performed by or for the business directory publisher, for example using business directory publisher billing systems, methods and/or computer program products 110 of FIG. 1 and/or Block 210 of FIG. 2. These operations may be performed in conjunction with the operations of FIGS. 3 and/or 4, or separate therefrom.

Referring to FIG. 5, at Block 510, a reminder message is electronically sent to the CMR if the CMR has not electronically accessed the electronically linked electronic image and electronic invoice within a predetermined time after the granting of electronic access. Accordingly, the CMR can be prodded to process its bill in a timely manner. In other embodiments of the present invention, as shown at Block 520, an electronic CMR credit/debit form is accepted by or for the business directory publisher. The electronic CMR credit/debit form indicates that an error was made in the electronic invoice for the business directory advertisement that was sold by the CMR for the business directory publisher. Finally, at Block 530, an electronic CMR adjustment form is accepted by or for the business directory publisher. The electronic CMR adjustment form indicates that an error was made in the business directory advertisement that was sold by the CMR for the business directory publisher and allows the publisher to take timely corrective measures. It will be understood that subcombinations of Blocks 510, 520 and 530 also may be performed in combination with, or separate from, the operations of FIGS. 2, 3 and/or 4.

FIG. 6 is a flowchart of operations that may be performed by a CMR billing system, method and/or computer program product, such as the CMR billing systems, methods and/or computer program products 120 of FIG. 1 and/or Block 220 of FIG. 2. As shown in FIG. 6, at Block 610, an electronically linked electronic image of a business directory advertisement that was sold by the CMR to a CMR customer and a CMR electronic invoice for the business directory advertisement are electronically accessed, in response to granting access to the electronically linked electronic image and electronic invoice by the business directory publisher. Electronic access may be provided as was already described in connection with Blocks 340 and/or 430, and will not be repeated for the sake of brevity.

At Block 620, the CMR generates a customer electronic invoice for the business directory advertisement that was sold by the CMR to the CMR customer, from the CMR electronic invoice for the business directory advertisement that was sold by the CMR to the CMR customer. The customer electronic invoice may use data from the spreadsheet of the CMR electronic invoice and may add appropriate commissions or other fees that are charged by the CMR to the CMR customer. For example, the CMR electronic invoice may employ data from the CMR invoice or the CMR invoice itself with additional and/or altered data fields (i.e., adding commission, discount, etc.). At Block 630, the electronic image and the customer electronic invoice are electronically linked, for example using the techniques that were described in Block 330 above. Finally, electronic access is granted to the CMR customer to the electronically linked electronic image and customer electronic invoice at Block 640. Electronic access may be granted using any of the techniques that were described in connection with Blocks 340 and/or 430. Accordingly, a CMR may paperlessly bill its customer using the electronic tear page that was provided by the business directory publisher and an invoice that may be generated from the invoice that was provided by the business directory publisher. Paperless distribution of tear pages and CMR invoices to CMR customers thereby may be provided.

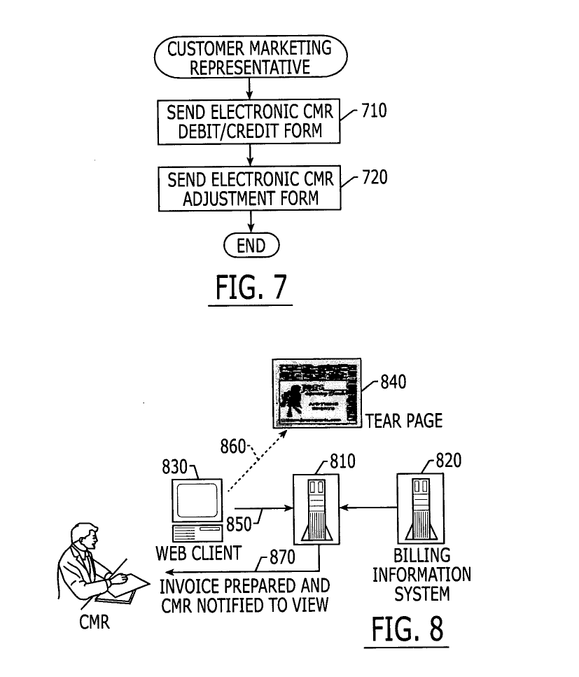

FIG. 7 is a flowchart of other operations that may be performed by a CMR billing system, method and/or computer program product, such as CMR billing systems, methods or computer program products 120 of FIG. 1 or Block 220 of FIG. 2. In particular, at Block 710, an electronic CMR debit/credit form is sent to the business directory publisher that indicates that an error was made in the CMR electronic invoice for the business directory advertisement that was sold by the CMR to the CMR customer for the business directory publisher. At Block 720, an electronic CMR adjustment form may be sent to the business directory publisher that indicates that an error was made in the business directory advertisement that was sold by the CMR to the CMR customer for the business directory publisher. Operations at Blocks 710 and 720 may be analogous to operations of Blocks 520 and 530, and will not be described again for the sake of brevity. Moreover, subcombinations of Blocks 710 and 720 also may be performed in combination with, or separate from, the operations of FIGS. 2 and/or 6.

FIG. 8 is a functional block diagram of other embodiments of the present invention. In particular, first and second application servers 810 and 820, respectively, may form part of a business directory publisher billing system, method and/or computer program product 110 of FIG. 1. The second application server 820 can be a billing information system that is used to generate electronic invoices which were then printed and mailed to the CMRs. However, in embodiments of the present invention, the billing information provided by the second application server 820 can be provided to the first application server 810 in electronic form to prepare an electronic invoice. Moreover, an advertisement may be created by an artist by or for the business directory publisher. The advertisement may be created electronically and/or created manually and electronically stored. Rather than printing out the tear page 840 and mailing the tear page 840 to the customer, the electronically generated tear page 840 may be maintained in its electronic form.

Continuing with the description of FIG. 8, the first application server 810 prepares the electronic invoices from the financial information provided by the second server 820, and then sends an email to the CMR billing system, method and/or computer program product 120, represented in FIG. 8 as a web client 830, as shown by arrow 870. The email can notify the CMR of the location of the electronic invoice, and may provide a link to the electronic tear page 840. As shown in FIG. 8 by arrow 850, the web client 830 can access or view the electronic invoice via the first application server 810 and, as shown by arrow 860, may also view the electronic tear page 840. In some embodiments, once an advertisement is created by an artist, the invoice is prepared and the CMR is sent a link via email with a user name and password. The CMR can then click on the link or visit the business directory operator website and, using the userid and password, log in to view their invoice(s) and tear page(s).

### EXAMPLES

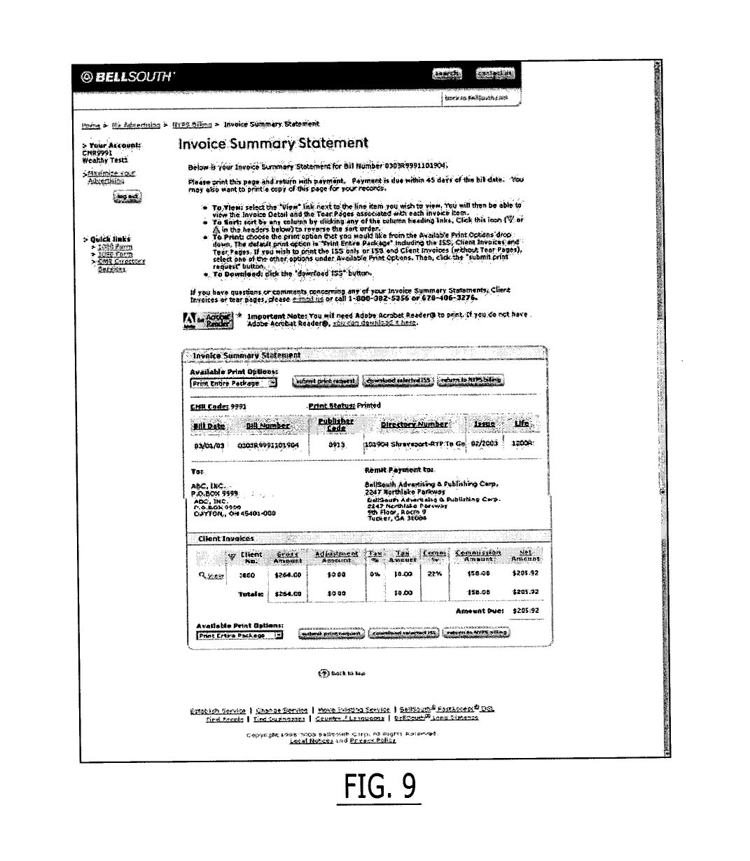

FIGS. 9-14 provide examples of user interfaces that may be used in some embodiments of the present invention. These examples shall be regarded as merely illustrative and shall not be construed as limiting the invention.

FIGS. 9-14 contain material that is subject to copyright protection. The copyright owner, BellSouth Corporation, Atlanta, Ga., has no objection to the reproduction or copying by anyone of the present patent document, as it appears in the Patent and Trademark Office patent file or records, but otherwise reserves all rights whatsoever.

FIG. 9 provides an example of a user interface that can provide an invoice summary statement corresponding, for example, to Block 420 of FIG. 4. As shown in FIG. 9, a client may view any of the invoices listed in the invoice summary by clicking on the “View” hyperlink and/or by using a browser bookmark. It also will be understood that, prior to obtaining the user interface of FIG. 9, the user may be authenticated. The “Available Print Options” scrollbox allows the CMR to print the entire package, the invoice summary statement, or the invoice summary statement and invoices. The “Print Status” hyperlink allows the CMR to see if this invoice summary statement has been downloaded, printed or both.

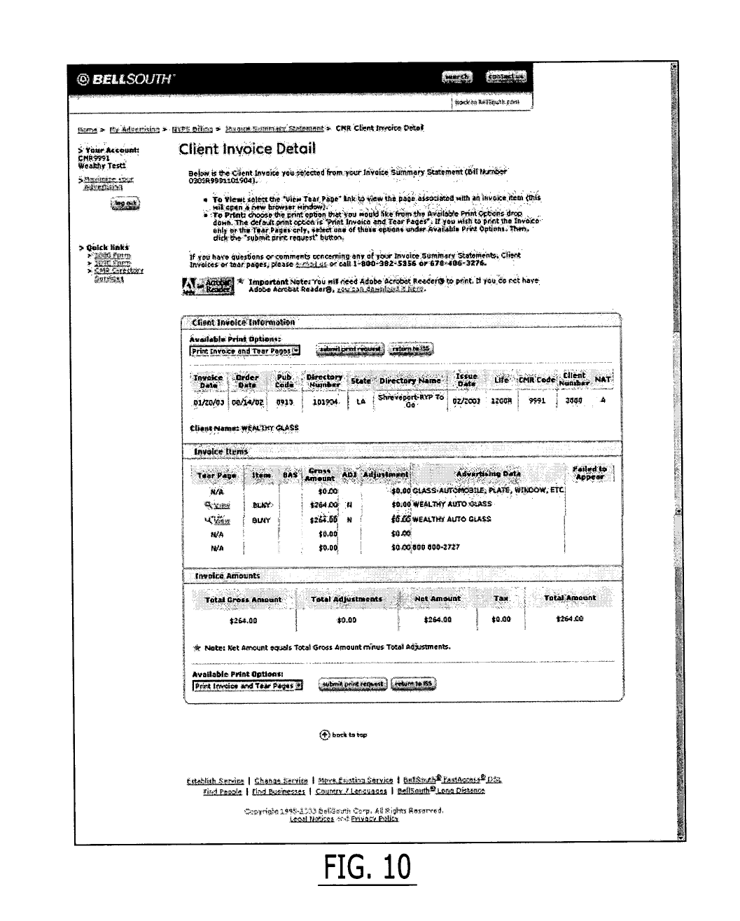

FIG. 10 provides an example of a CMR electronic invoice, with fictitious data included, as was described, for example, at Block 320 of FIGS. 3 and 4. As shown in FIG. 10, each invoice item includes a “View” hyperlink, which allows the CMR to electronically access the electronic image of a business directory advertisement that was sold by the CMR for the business directory publisher. The “Available Print Options” scrollbox may function as was described in connection with

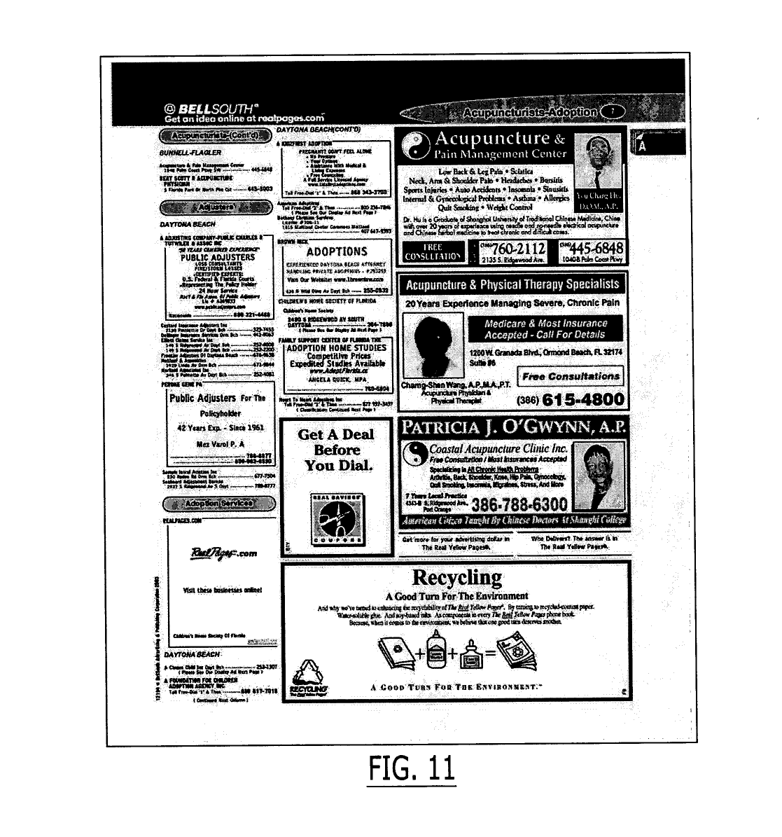

FIG. 11 illustrates an example of an electronic image of a business directory advertisement (electronic tear page), such as was described in connection with Block 310 of FIGS. 3 and 4. In some embodiments, the electronic tear page includes an entire page of the business directory that includes the business directory advertisement that is being invoiced. In other embodiments, only a portion of the business directory page that includes the business directory advertisement may be included in the electronic tear page. In still other embodiments, only the business directory advertisement itself is included in the electronic tear page.

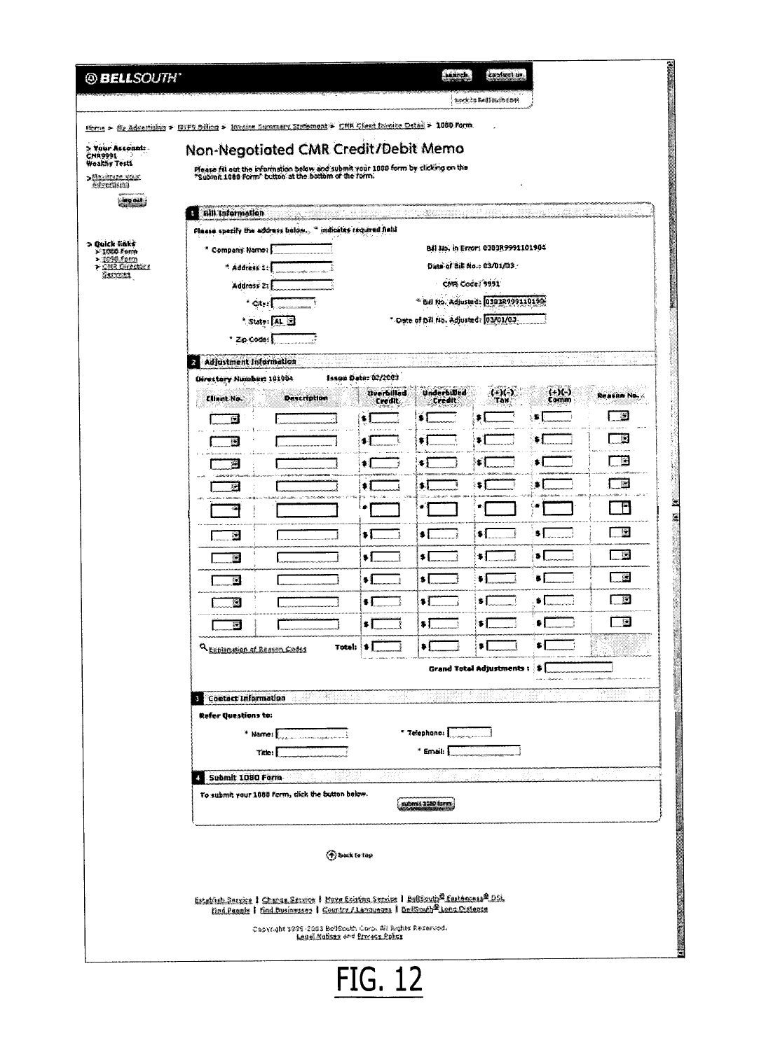

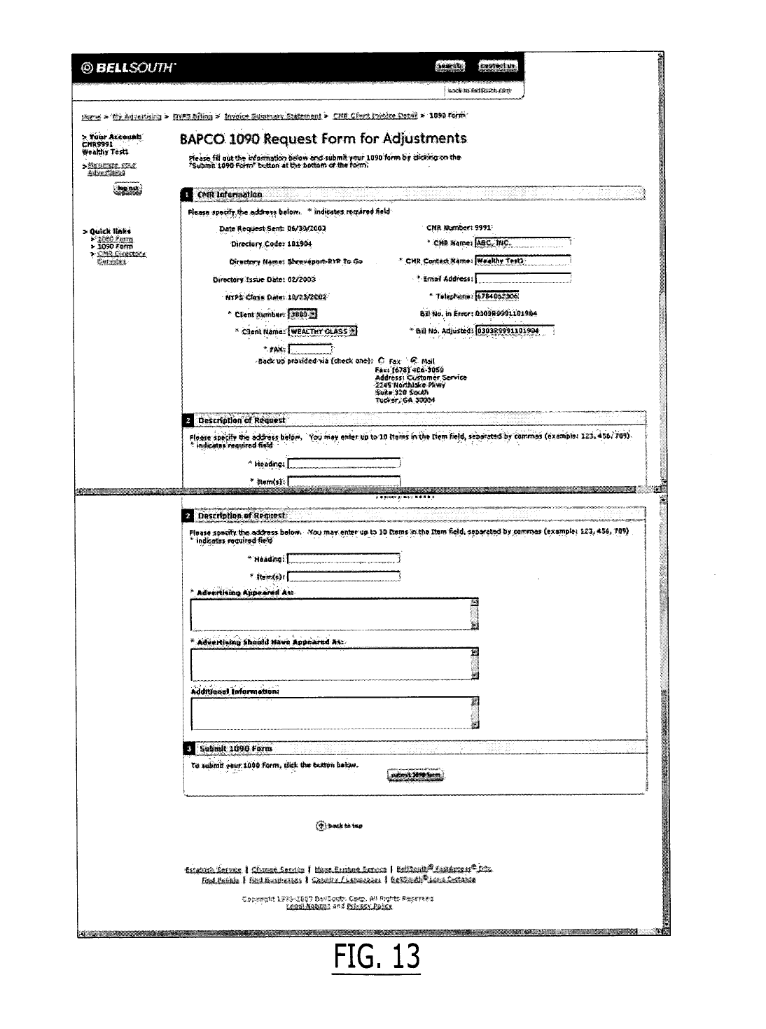

FIG. 12 is an example of a user interface that may be provided to generate a CMR credit/debit memo, also referred to as a “1080 Form”, such as was described in connection with Block 520 of FIG. 5. FIG. 13 is an example of a user interface that may be used to generate an electronic CMR adjustment form, also referred to as a “1090 Form”, that was described in connection with Block 530 of FIG. 5. The 1080 and 1090 Forms are commonly used in conventional business directory advertising and need not be described in detail herein.

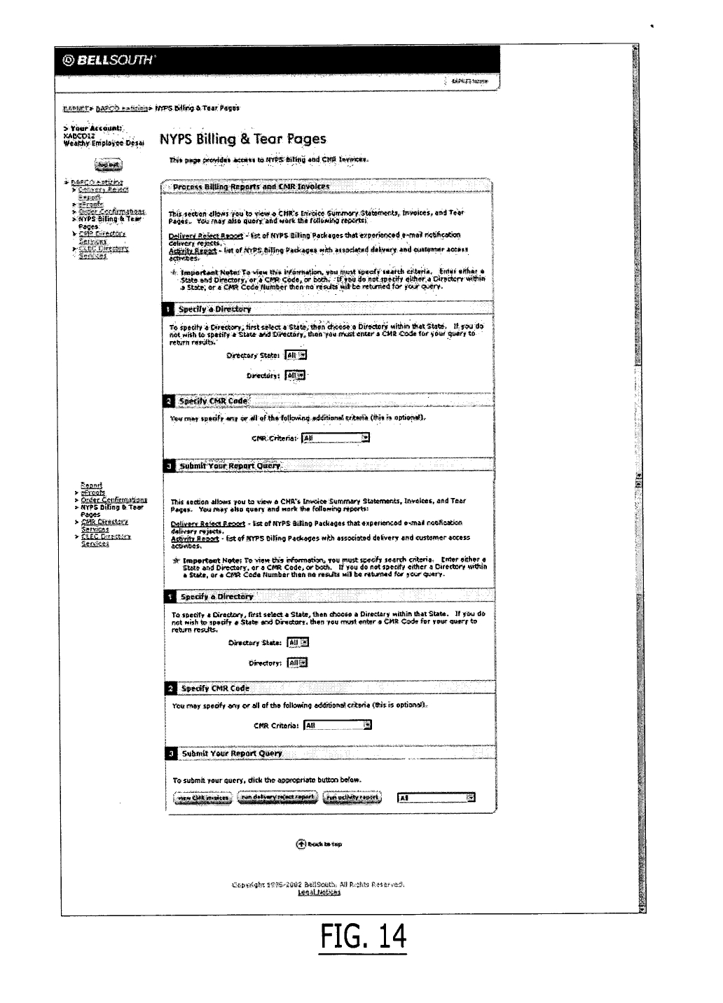

FIG. 14 illustrates an example of a user interface that may be used by or for the business directory publisher to determine whether a CMR invoice has been paid within a predetermined time, and thereby electronically send a reminder, corresponding to Block 510 of FIG. 5. The reminder may be automated and/or carried out responsive to a directory publisher representative query.

In view of the above, embodiments of the present invention can paperlessly distribute tear pages and business directory publisher invoices to CMRs. Moreover, embodiments of the present invention can paperlessly distribute tear pages and CMR invoices to CMR customers. The potential costs associated with paper tear pages, paper invoices, printing, mailing and/or other manual labor can be reduced or minimized.

In the drawings and specification, there have been disclosed embodiments of the invention and, although specific terms are employed, they are used in a generic and descriptive sense only and not for purposes of limitation, the scope of the invention being set forth in the following claims.

1. A business directory advertisement billing method comprising:
generating an electronic image of a business directory advertisement that was sold by a third party Customer Marketing Representative (CMR) for a business directory publisher;
generating an electronic invoice for the business directory advertisement that was sold by the CMR for the business directory publisher;
electronically linking the electronic image and the electronic invoice; and
granting electronic access to the CMR to the electronic image and electronic invoice that are electronically linked.

2. A method according to claim 1 wherein the granting electronic access comprises:
sending an email to the CMR including a hyperlink to the electronic image and electronic invoice that are electronically linked.

3. A method according to claim 1 wherein the granting electronic access comprises:
sending an email to the CMR including a userid and/or password that may be used to electronically access the electronic image and electronic invoice that are electronically linked.

4. A method according to claim 1 wherein the electronically linking comprises generating a hyperlink to the electronic image in the electronic invoice.

5. A method according to claim 1:
wherein the generating an electronic image, generating an electronic invoice and electronically linking are repeatedly performed for a plurality of business directory advertisements that were sold by the CMR for the business directory publisher to create an invoice summary statement; and
wherein the granting electronic access comprises granting electronic access to the CMR to the invoice summary statement.

6. A method according to claim 1 wherein the generating an electronic image comprises generating a read only Portable Document Format (PDF) file that contains the image of the business directory advertisement that was sold by the CMR for the business directory publisher.

7. A method according to claim 1 wherein the generating an electronic invoice comprises generating an electronic spreadsheet that contains the electronic invoice for the business directory advertisement that was sold by the CMR for the business directory publisher.

8. A method according to claim 1 further comprising:
electronically sending a reminder message to the CMR if the CMR has not electronically accessed the electronic image and electronic invoice that are electronically linked, within a predetermined time after the granting electronic access.

9. A method according to claim 1 further comprising:
accepting an electronic CMR credit/debit form that indicates that an error was made in the electronic invoice for the business directory advertisement that was sold by the CMR for the business directory publisher.

10. A method according to claim 1 further comprising:
accepting an electronic CMR adjustment form that indicates that an error was made in the business directory advertisement that was sold by the CMR for the business directory publisher.

11. A business directory advertisement billing method comprising:
electronically accessing an electronically linked electronic image of a business directory advertisement that was sold by a third party Customer Marketing Representative (CMR) for a business directory publisher to a CMR customer and a CMR electronic invoice for the business directory advertisement that was sold by the CMR to the CMR customer, in response to granting access to the electronically linked electronic image and electronic invoice by the business directory publisher;
generating a customer electronic invoice for the business directory advertisement that was sold by the CMR to the CMR customer, from the CMR electronic invoice for the business directory advertisement that was sold by the CMR to the CMR customer;
electronically linking the electronic image and the customer electronic invoice; and
granting electronic access to the CMR customer to the electronic image and customer electronic invoice that are electronically linked.

12. A method according to claim 11 wherein the granting electronic access comprises:
sending an email to the CMR customer including a hyperlink to the electronic image and customer electronic invoice that are electronically linked.

13. A method according to claim 11 wherein the granting electronic access comprises:
sending an email to the CMR customer including a userid and/or password that may be used to electronically access the electronic image and customer electronic invoice that are electronically linked.

14. A method according to claim 11 wherein the electronic image comprises a read only Portable Document Format (PDF) file that contains the image of the business directory advertisement that was sold by the CMR to the CMR customer for the business directory publisher.

15. A method according to claim 11 further comprising:
sending an electronic CMR credit/debit form to the business directory publisher that indicates that an error was made in the CMR electronic invoice for the business directory advertisement that was sold by the CMR to the CMR customer for the business directory publisher.

16. A method according to claim 11 further comprising:
sending an electronic CMR adjustment form to the business directory publisher that indicates that an error was made in the business directory advertisement that was sold by the CMR to the CMR customer for the business directory publisher.

17. An advertisement billing method comprising:
generating an electronic image of an advertisement that was sold by a third party Marketing Representative (MR) for a publisher;
generating an electronic invoice for the advertisement that was sold by the MR for the publisher;
electronically linking the electronic image and the electronic invoice; and
granting electronic access to the MR to the electronic image and electronic invoice that are electronically linked.

18. A method according to claim 17 wherein the granting electronic access comprises:
sending an email to the MR including a hyperlink to the electronic image and electronic invoice that are electronically linked.

19. A method according to claim 17 wherein the granting electronic access comprises:
sending an email to the MR including a userid and password that may be used to electronically access the electronic image and electronic invoice that are electronically linked.

20. A method according to claim 17 wherein the generating an electronic image comprises generating a read only Portable Document Format (PDF) file that contains the image of the advertisement that was sold by the MR for the publisher.

21. A method according to claim 17 wherein the generating an electronic invoice comprises generating an electronic spreadsheet that contains the electronic invoice for the advertisement that was sold by the MR for the periodical publisher.

22. A business directory advertisement billing method comprising:
paperlessly distributing to third party Customer Marketing Representatives (CMR) for a business directory publisher, tear pages and corresponding business directory publisher invoices for business directory advertisements that were sold by the CMRs to CMR customers.

23. A method according to claim 22 further comprising:
paperlessly distributing to the CMR customers, the tear pages and CMR customer invoices for business directory advertisements that were sold by the CMRs to the CMR customers.

24. A business directory advertisement billing system comprising:
an electronic image of a business directory advertisement that was sold by a third party Customer Marketing Representative (CMR) for a business directory publisher;
an electronic invoice for the business directory advertisement that was sold by the CMR for the business directory publisher; and
a module that is configured to electronically link the electronic image and the electronic invoice and to grant electronic access to the CMR to the electronic image and electronic invoice that are electronically linked.

25. A system according to claim 24 wherein the module is configured to grant electronic access by sending an email to the CMR including a hyperlink to the electronic image and electronic invoice that are electronically linked.

26. A system according to claim 24 wherein the module is configured to grant electronic access by sending an email to the CMR including a userid and/or password that may be used to electronically access the electronic image and electronic invoice that are electronically linked.

27. A system according to claim 24 wherein the module is configured to electronically link by generating a hyperlink to the electronic image in the electronic invoice.

28. A system according to claim 24 wherein the module is further configured to electronically send a reminder message to the CMR if the CMR has not electronically accessed the electronic image and electronic invoice that are electronically linked, within a predetermined time after the granting electronic access.

29. A system according to claim 24 wherein the module is further configured to accept an electronic CMR credit/debit form that indicates that an error was made in the electronic invoice for the business directory advertisement that was sold by the CMR for the business directory publisher.

30. A system according to claim 24 wherein the module is further configured to accept an electronic CMR adjustment form that indicates that an error was made in the business directory advertisement that was sold by the CMR for the business directory publisher.

31. A business directory advertisement billing system comprising:
a module that is configured to electronically access an electronically linked electronic image of a business directory advertisement that was sold by a third party Customer Marketing Representative (CMR) for a business directory publisher to a CMR customer and a CMR electronic invoice for the business directory advertisement that was sold by the CMR to the CMR customer, in response to granting access to the electronically linked electronic image and electronic invoice by the business directory publisher;
the module being further configured to generate a customer electronic invoice for the business directory advertisement that was sold by the CMR to the CMR customer, from the CMR electronic invoice for the business directory advertisement that was sold by the CMR to the CMR customer, to electronically link the electronic image and the customer electronic invoice, and to grant electronic access to the CMR customer to the electronic image and customer electronic invoice that are electronically linked.

32. A system according to claim 31 wherein the module is configured to grant electronic access by sending an email to the CMR customer including a hyperlink to the electronic image and customer electronic invoice that are electronically linked.

33. A system according to claim 31 wherein the module is configured to grant electronic access by sending an email to the CMR customer including a userid and/or password that may be used to electronically access the electronic image and customer electronic invoice that are electronically linked.

34. An advertisement billing system comprising:
an electronic image of an advertisement that was sold by a third party Marketing Representative (MR) for a publisher;
an electronic invoice for the advertisement that was sold by the MR for the publisher; and
a module that is configured to electronically link the electronic image and the electronic invoice and to grant electronic access to the MR to the electronic image and electronic invoice that are electronically linked.

35. A system according to claim 34 wherein the module is configured to grant electronic access by sending an email to the MR including a hyperlink to the electronic image and electronic invoice that are electronically linked.

36. A system according to claim 34 wherein the module is configured to grant electronic access by sending an email to the MR including a userid and password that may be used to electronically access the electronic image and electronic invoice that are electronically linked.

37. A business directory advertisement billing system comprising:
a module that is configured to paperlessly distribute to third party Customer Marketing Representatives (CMR) for a business directory publisher, tear pages and business directory publisher invoices for business directory advertisements that were sold by the CMRs to CMR customers.

38. A system according to claim 37 wherein the module is further configured to paperlessly distribute to the CMR customers, the tear pages and CMR customer invoices for business directory advertisements that were sold by the CMRs to the CMR customers.

39. A computer program product for business directory advertisement billing, the computer program product comprising a computer usable storage medium having computer-readable program code embodied in the medium, the computer-readable program code comprising:
computer-readable program code that is configured to generate an electronic image of a business directory advertisement that was sold by a third party Customer Marketing Representative (CMR) for a business directory publisher;
computer-readable program code that is configured to generate an electronic invoice for the business directory advertisement that was sold by the CMR for the business directory publisher;
computer-readable program code that is configured to electronically link the electronic image and the electronic invoice; and
computer-readable program code that is configured to grant electronic access to the CMR to the electronic image and electronic invoice that are electronically linked.

40. A computer program product according to claim 39 wherein the computer-readable program code that is configured to grant electronic access comprises:
computer-readable program code that is configured to send an email to the CMR including a hyperlink to the electronic image and electronic invoice that are electronically linked.

41. A computer program product according to claim 39 wherein the computer-readable program code that is configured to grant electronic access comprises:
computer-readable program code that is configured to send an email to the CMR including a userid and/or password that may be used to electronically access the electronic image and electronic invoice that are electronically linked.

42. A computer program product according to claim 39 wherein the computer-readable program code that is configured to electronically link comprises computer-readable program code that is configured to generate a hyperlink to the electronic image in the electronic invoice.

43. A computer program product according to claim 39:
wherein the computer-readable program code that is configured to generate an electronic image, the computer-readable program code that is configured to generate an electronic invoice and the computer-readable program code that is configured to electronically link are repeatedly activated for a plurality of business directory advertisements that were sold by the CMR for the business directory publisher to create an invoice summary statement; and
wherein the computer-readable program code that is configured to grant electronic access comprises computer-readable program code that is configured to grant electronic access to the CMR to the invoice summary statement.

44. A computer program product according to claim 39 wherein the computer-readable program code that is configured to generate an electronic image comprises computer-readable program code that is configured to generate a read only Portable Document Format (PDF) file that contains the image of the business directory advertisement that was sold by the CMR for the business directory publisher.

45. A computer program product according to claim 39 wherein the computer-readable program code that is configured to generate an electronic invoice comprises computer-readable program code that is configured to generate an electronic spreadsheet that contains the electronic invoice for the business directory advertisement that was sold by the CMR for the business directory publisher.

46. A computer program product according to claim 39 further comprising:
computer-readable program code that is configured to electronically send a reminder message to the CMR if the CMR has not electronically accessed the electronic image and electronic invoice that are electronically linked, within a predetermined time after the granting electronic access.

47. A computer program product according to claim 39 further comprising:
computer-readable program code that is configured to accept an electronic CMR credit/debit form that indicates that an error was made in the electronic invoice for the business directory advertisement that was sold by the CMR for the business directory publisher.

48. A computer program product according to claim 39 further comprising:
computer-readable program code that is configured to accept an electronic CMR adjustment form that indicates that an error was made in the business directory advertisement that was sold by the CMR for the business directory publisher.

49. A computer program product for business directory advertisement billing, the computer program product comprising a computer usable storage medium having computer-readable program code embodied in the medium, the computer-readable program code comprising:
computer-readable program code that is configured to electronically access an electronically linked electronic image of a business directory advertisement that was sold by a third party Customer Marketing Representative (CMR) for a business directory publisher to a CMR customer and a CMR electronic invoice for the business directory advertisement that was sold by the CMR to the CMR customer, in response to granting access to the electronically linked electronic image and electronic invoice by the business directory publisher;
computer-readable program code that is configured to generate a customer electronic invoice for the business directory advertisement that was sold by the CMR to the CMR customer, from the CMR electronic invoice for the business directory advertisement that was sold by the CMR to the CMR customer;
computer-readable program code that is configured to electronically link the electronic image and the customer electronic invoice; and
computer-readable program code that is configured to grant electronic access to the CMR customer to the electronic image and customer electronic invoice that are electronically linked.

50. A computer program product according to claim 49 wherein the computer-readable program code that is configured to grant electronic access comprises:
computer-readable program code that is configured to send an email to the CMR customer including a hyperlink to the electronic image and customer electronic invoice that are electronically linked.

51. A computer program product according to claim 49 wherein the computer-readable program code that is configured to grant electronic access comprises:
computer-readable program code that is configured to send an email to the CMR customer including a userid and/or password that may be used to electronically access the electronic image and customer electronic invoice that are electronically linked.

52. A computer program product according to claim 49 wherein the electronic image comprises a read only Portable Document Format (PDF) file that contains the image of the business directory advertisement that was sold by the CMR to the CMR customer for the business directory publisher.

53. A computer program product according to claim 49 further comprising:
computer-readable program code that is configured to send an electronic CMR credit/debit form to the business directory publisher that indicates that an error was made in the CMR electronic invoice for the business directory advertisement that was sold by the CMR to the CMR customer for the business directory publisher.

54. A computer program product according to claim 49 further comprising:
computer-readable program code that is configured to send an electronic CMR adjustment form to the business directory publisher that indicates that an error was made in the business directory advertisement that was sold by the CMR to the CMR customer for the business directory publisher.

55. A computer program product for advertisement billing, the computer program product comprising a computer usable storage medium having computer-readable program code embodied in the medium, the computer-readable program code comprising:
computer-readable program code that is configured to generate an electronic image of an advertisement that was sold by a third party Marketing Representative (MR) for a publisher;
computer-readable program code that is configured to generate an electronic invoice for the advertisement that was sold by the MR for the publisher;
computer-readable program code that is configured to electronically link the electronic image and the electronic invoice; and
computer-readable program code that is configured to grant electronic access to the MR to the electronic image and electronic invoice that are electronically linked.

56. A computer program product according to claim 55 wherein the computer-readable program code that is configured to grant electronic access comprises:
computer-readable program code that is configured to send an email to the MR including a hyperlink to the electronic image and electronic invoice that are electronically linked.

57. A computer program product according to claim 55 wherein the computer-readable program code that is configured to grant electronic access comprises:
computer-readable program code that is configured to send an email to the MR including a userid and password that may be used to electronically access the electronic image and electronic invoice that are electronically linked.

58. A computer program product according to claim 55 wherein the computer-readable program code that is configured to generate an electronic image comprises computer-readable program code that is configured to generate a read only Portable Document Format (PDF) file that contains the image of the advertisement that was sold by the MR for the publisher.

59. A computer program product according to claim 55 wherein the computer-readable program code that is configured to generate an electronic invoice comprises generating an electronic spreadsheet that contains the electronic invoice for the advertisement that was sold by the MR for the periodical publisher.

60. A computer program product for business directory advertisement billing, the computer program product comprising a computer usable storage medium having computer-readable program code embodied in the medium, the computer-readable program code comprising:
computer-readable program code that is configured to paperlessly distribute to third party Customer Marketing Representatives (CMR) for a business directory publisher, tear pages and business directory publisher invoices for business directory advertisements that were sold by the CMRs to CMR customers.

61. A computer program product according to claim 60 further comprising:
computer-readable program code that is configured to paperlessly distribute to the CMR customers, the tear pages and CMR customer invoices for business directory advertisements that were sold by the CMRs to the CMR customers.
